(19) United States
(12) Patent Application Publication
(10) Pub. No.: US 2014/0095334 A1
(43) Pub. Date: Apr. 3, 2014

(54) SYSTEM AND METHOD FOR PROCESSING PRODUCT UPGRADE TRANSACTIONS

(71) Applicant: BARCLAYS BANK PLC, London (GB)

(72) Inventor: Loren BARTON, London (GB)

(73) Assignee: BARCLAYS BANK PLC, London (GB)

(21) Appl. No.: 13/631,336

(22) Filed: Sep. 28, 2012

(51) Int. Cl. G06Q 30/06

(52) U.S. Cl. 705/26.1

(57) ABSTRACT

A system and method for facilitating upgrade transactions for certain purchased products is disclosed. Information regarding a purchased product may be stored in a database, and upgrade options and upgrade pricing information regarding the purchased product may be displayed to the customer. A mobile application may be used by the customer to purchase the original product, and the mobile application may further allow the customer to track upgrade options for the product and to initiate the upgrade transaction. When a customer initiates an upgrade transaction, an upgrade payment is matched to the originally purchased product. The upgrade payment may be sent from the mobile application. The system and method may then arrange for the return, or trade-in, of the originally purchased product as well as the delivery or pick-up of the upgrade product.

### TECHNICAL FIELD

The application is directed to product purchasing and product upgrades, and in particular to a method and system that track purchased items and display upgrade options and prices for a customer to trade-in and upgrade purchased items as many times as desired.

### BACKGROUND OF THE INVENTION

Customers often want the latest version of many products on the market today, and sometimes feel conflicted about purchasing an item if they suspect a newer model or updated version may be introduced. Customers often have to weigh purchasing the available version of a product against the ability to purchase any newer models that may be introduced before they would be ready to purchase the same type of product again. This can be a concern for retailers and manufacturers who rely on repeat purchases of their premium or high-end products.

With certain products, such as electronics or automobiles, new models or versions are being introduced with greater frequency. This has led to customers feeling trapped when they purchase the product only to find out that a newer or better model is released shortly thereafter, leaving them with what they consider to be an “outdated” model.

Although retailers may have existing buy-back programs for products, these typically involve a cash or cash-equivalent payment to the customer instead of a direct upgrade to the newer model. Additionally, existing buy-back or trade-in programs usually require some form of pricing algorithm and a subjective human evaluation of the returned product to determine the trade-in value. A customer may be forced to return the product to a store for a pricing evaluation, or may be required to ship the product back to a retailer or manufacturer and then wait for an evaluation to be performed there before knowing the cash or cash-equivalent amount they will receive for their previously purchased product. These programs also involve an additional purchase transaction, conducted online or in-store, subsequent to the cash or cash-equivalent trade-in of a previously purchased product before a customer obtains the newer product model. These existing buy-back and trade-in programs are often supplemental to the initial product purchase, and sometimes involve a separate purchase of the right to participate in the program. Therefore, the ability to upgrade is not fundamental to the initial purchase decision, and completing all of the necessary steps and transactions to return or trade in a previously purchased product and obtain possession of a newer product is cumbersome and time consuming for the consumer.

Other trade-in programs may allow a customer to upgrade to a newer model, but only after a specified time period or when an existing service contract is over. For example, a wireless phone retailer may allow a customer to purchase a new model phone at a discounted price, but only when the customer's existing contract is renewed for a specified time period. This discounted price only reflects the new service contract and is not a reflection of a trade-in upgrade from an old product to the new product, and the customer may be left with the previously purchased model.

For some products, the customers may have no trade-in or buy-back options. This may force customers to find a third party willing to purchase the old device before they are able to purchase the upgraded model.

As the lifespan of products has become shorter, and as newer models of products are being introduced at increasingly frequent rates, a system and method providing for an easy upgrade of a purchased item to a newer model without complicated trade-in evaluations or buy-back cash or cash-equivalent transaction steps is required. The system and method described herein allow for a customer to quickly and easily upgrade previously purchased items to new models whenever desired, without penalizing the retailer or manufacturer as is the case in some other prior product return systems wherein the manufacturer or retailer may be forced to pay a customer for a returned device without also selling a new product to the customer at the same time. In the system and method described herein, the product return to the manufacturer is part of the same upgrade transaction that includes the sale and shipment of the new, updated model of the product to the customer.

### SUMMARY

The present application is directed to a system and method for processing product upgrade transactions. Customers may purchase products eithers in a retail store or online, and the payment transaction information to purchase the product is processed by or entered into a digital purchased product upgrade application. The purchase may be completed with a purchase transaction module within the purchased product upgrade application. The digital purchased product upgrade application stores the information related to the item purchased, tracks items purchased, and displays product upgrade options and upgrade pricing options in real-time. The application may be stored on a server and accessible as a website hosted on a network, or may be stored as an application program on a mobile device.

A central database stored on a server acquires and stores information regarding purchased products, as well as information regarding new models and versions of products, which may be presented to customers as upgrade options. The central database further stores pricing information for each upgrade option. The central database and server may be hosted by the payment issuer, or may be hosted by a third party. The upgrade options are part of the original product purchase transaction, and a customer need only select the upgrade option for previously purchased products in order to both initiate a second transaction to trade in the originally purchased product and receive the upgraded model of the product.

The trade-in of a previously purchased product is therefore linked to the purchase of a new model, or upgrade, of that product. After purchase of a product, a customer may use the purchased product upgrade application to view purchased items that include the upgrade option, view upgrade options for each purchased product, and view the real-time price required to complete the upgrade transactions of trading in the originally purchased product for the upgrade product. The purchased product upgrade application may be accessed as a website through a computing device connected to a network, or may be accessed through a mobile application on a smartphone, tablet, or other mobile device. When a customer initiates the upgrade option through a upgrade request module within the purchased product upgrade application, the purchased product upgrade application notifies the manufacturer and retailer that the customer has selected this option. The manufacturer and retailer may then arrange for pickup of the originally purchased product, drop off the originally purchased product, and delivery of the upgrade new model product. In an alternative embodiment, the application may provide the customer the option to drop off the originally purchased product at a retailer or manufacturer location, and to pick up the upgrade new model product at the retailer or manufacturer.

Upon completion of the upgrade request by the customer, the payment issuer may send the upgrade payment to the upgrade system hosted on the central database. The upgrade payment may be matched to the original purchase. After this match is completed, the upgrade system sends the payment to the manufacturer or retailer to complete the transaction.

At the initial product purchase, the customer would have access to the initial product purchase price as well as the upgrade price required to initiate the upgrade transaction for an upgrade of the initial product, if an upgrade product exists at that time. If the initial product is the most current version of the product such that no upgrade option exists at the time of the initial purchase transaction, the customer may only be provided with the initial product purchase price as well as an indication that upgrade purchase price options will be provided in the future if and when an upgrade product becomes available. Any upgrade option prices related to the initial product purchase are displayed to the customer as they are available. These upgrade prices change over time to reflect the change in value of the initially purchased product that would be exchanged for the upgrade product. According to some embodiments, the upgrade option prices may reflect the difference between the price of the upgrade product and a current value of the initially purchased product. This current value of the initially purchased product may be predetermined according to the initial product purchase price, and the amount of time that has passed since the initial purchase. Both initial product purchase prices and upgrade option prices may be stored in the upgrade system

### BRIEF DESCRIPTION OF THE DRAWINGS

FIG. 1 is an illustration of a customer purchase and payment transaction for an original, or initial, product.

FIG. 2 illustrates the product upgrade system that tracks purchases products, stores product and pricing information for original and upgrade products, links manufacturer information to purchase transactions, and loads the information regarding upgrade options and pricing information into the purchased product upgrade application.

FIG. 3 illustrates an exemplary embodiment of the upgrade request and customer fulfillment process.

FIG. 4 illustrates the payment process associated with the upgrade transaction.

FIG. 5 is an illustration of the upgrade system, customer devices, and retailer and manufacturer components according to one embodiment of the present invention.

FIG. 6 is an illustration of the components of the upgrade payment system.

### DETAILED DESCRIPTION

A system and method for processing and completing product upgrade request transactions are disclosed. The system and method use a purchased product upgrade application, accessed through an online website or through a mobile application, to complete a product upgrade transaction from an initially purchased product to a newer version or upgraded model of the initially purchased product.

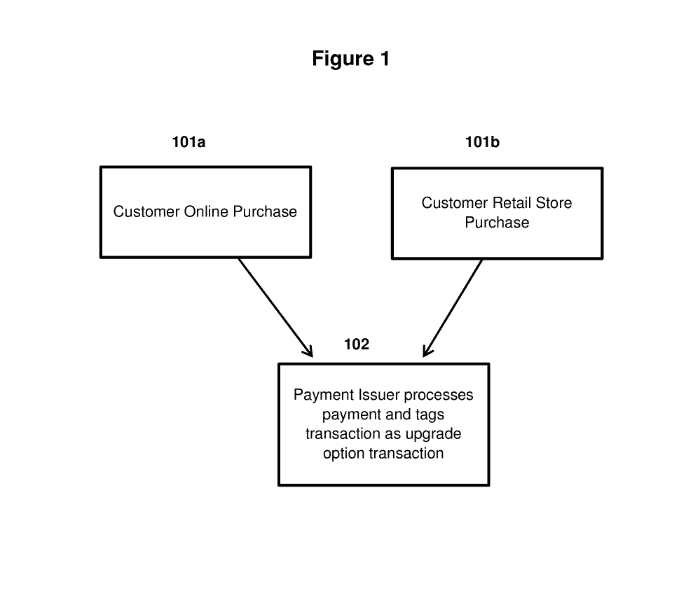

FIG. 1 illustrates a purchase payment transaction of an original product eligible for the product upgrade transactions, wherein a customer purchases a product currently for sale. The customer may purchase the product through an online transaction 101a by accessing a website offering the product for sale and selecting an option to buy the product. The customer may access the website through a user interface, wherein the user interface communicates with the website over a network, such as the internet or a local area network. The website may be hosted on a server run by a manufacturer, retailer, or product upgrade transaction service. The online transaction may also be completed through a mobile application providing a customer with a user interface through which the customer can view available products and select products for purchase. In an alternative embodiment, the customer may purchase the product in a retailer or manufacturer transaction 101b completed at a manufacturer or retail store location. In some embodiments, the purchased may include a label or other indicia indicating that it is eligible for the product upgrade transaction program. For example, the indicia could be a logo on the product or packaging, an icon a website displaying the product for purchase, or a pop up message if the product is purchased online or through a mobile application alerting the customer that the product they have purchased qualifies for the product upgrade program.

After a customer selects a product for purchase, a payment issuer processes the payment from the customer and tags the product purchase transaction as an upgrade option payment transaction 102. Once a transaction is tagged as upgrade option payment transaction 102, the customer is notified that they have the option to upgrade the purchased product to a new model or upgraded version of the product at any time in the future by accessing an upgrade system and selecting an upgrade option. The payment issuer may be a different entity from the retailer or manufacturer, such as a bank, credit card company, or other third party payment service. In some instances, such as where a retailer branded credit card is used to make a purchase from that retailer, the payment issuer may be the same party as the retailer or manufacturer. The payment issuer receives the payment information through the customer's use of a specific payment method associated with that payment issuer. For example, the payment issuer may be a credit card company and use of the credit card by the customer during a product purchase ensures that the payment information is received by the payment issuer. The payment issuer may also be a bank wherein a bank card or bank account number is used to complete the transaction, or the payment issuer may be a third party online or mobile payment service such as PayPal wherein a member ID or login is required to complete any purchase transactions. During the product purchase transaction, the barcode or other product identifying information may contain coded data specifying that the product is eligible for the upgrade option. When this coded data is recorded during the purchase transaction, it may initiate a process whereby the product purchase transaction information is automatically sent over a network connection to the payment issuer when a retail or online transaction is completed.

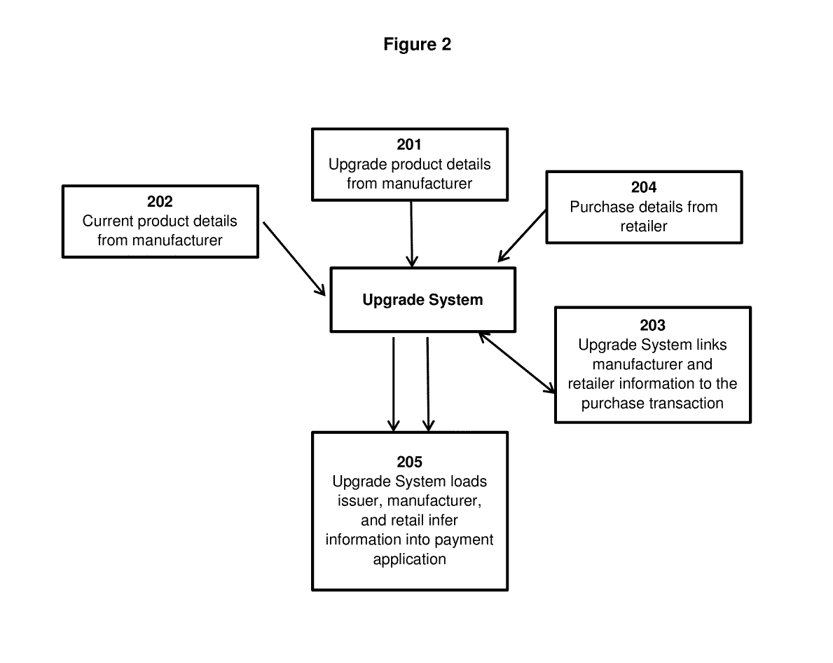

FIG. 2 illustrates the product upgrade system which tracks purchases products, stores product and pricing information for original and upgrade products, links manufacturer information to purchase transactions, and loads the information regarding upgrade options and pricing information into the purchased product upgrade application. The upgrade system includes a central database that stores all information related to purchased products, pricing information, and upgrade product options. The product manufacturer provides upgrade product details 201 including upgrade information, such as upgrade price, upgrade product description, upgrade product model, and an image of the upgrade product. The product manufacturer further provides current, or purchased, product details 202 including price, description, model, images of the purchased product, and other information to the upgrade system. Additional manufacturer information that may be stored in the central database includes the item number of the originally purchased product, the item numbers of available upgrades for that product, and participating retailers or online distribution sites. This manufacturer information related to the product details is sent along with the payment transaction to the upgrade system through a network connection. The upgrade system stores this information in the central database hosted on a server, and performs a linking process 203 to link this manufacturer provided information to any customer purchase transactions matching products stored in the database. Purchased products may be identified in the database based on model number, serial number, barcode, or other identifying information.

The retailer, which may be an online retailer selling products through a website or a retailer store location, provides additional purchase details 204 to the upgrade system. These additional purchase details 204 may include store location, online website address, retail purchase price, warranty information, and other information. These retailer product details may also be sent to the upgrade system through a network connection.

The issuer, manufacturer, and retail information are then loaded into a purchased product upgrade application 205 accessible by the customer. The central database, which stores the information, is in bidirectional communication with the purchased product upgrade application. As information about a purchased product or upgrade product is stored in the central database, the central database makes this information available to customers through the purchased product upgrade application. The purchased product upgrade application may be hosted on a website accessible through a user interface, such as a computer, smartphone, tablet, or personal digital assistant. The purchased product upgrade application may also be a mobile application that a user downloads onto a mobile device such as a smartphone or table computer.

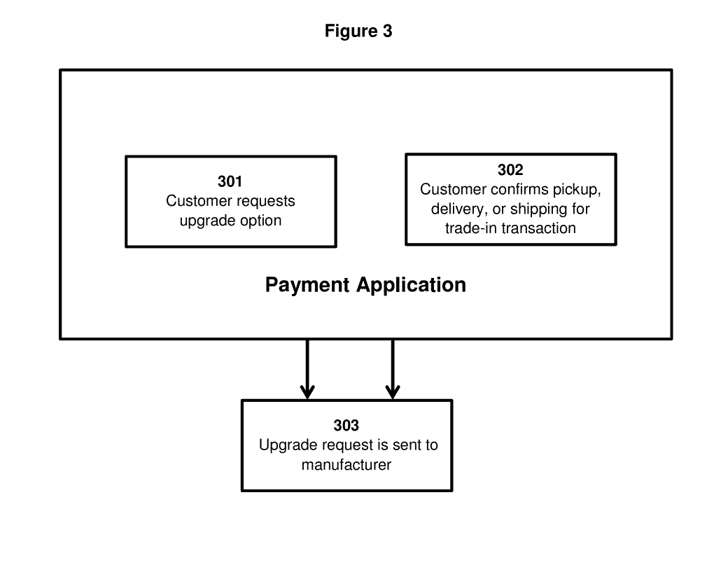

FIG. 3 illustrates an exemplary embodiment of the upgrade request and customer fulfillment process. As shown in FIG. 3, customers may log in to the upgrade option database through a user device containing a network communication interface. The purchased product upgrade application accesses the information stored in the central database, and finds all product information associated with the customer's previously purchased products. This information includes any currently available upgrade options, as well as real-time prices for executing the upgrade options. Upon logging in to the purchased product upgrade application, a display on the user device provides the purchased product and upgrade information to the customer. The purchased product upgrade application contains a selectable option, which may be in the form of an icon or selectable link, by which the customer can choose an upgrade option at the displayed prices. The customer makes a request to upgrade 301 through selecting this option in the purchased product upgrade application. After making the request to upgrade, the purchased product upgrade application provides the customer with selectable options for completing the trade-in and upgrade transaction 302. For example, the customer may select to have the manufacturer or retailer arrange for pickup of the originally purchased product and deliver of the upgrade product. The customer may also select to arrange for drop off of the originally purchased product at a participating retailer or manufacturer location, as well as pick of the new product at the same location. The purchased product upgrade application may also allow a customer to select a combination of shipping and drop off/pick up of the old and new products. Customers may confirm and fulfill the upgrade directly through the manufacturer, or at any participating retailer location.

The purchased product upgrade application directly links the selected upgrade product and upgrade payment price to the trade-in of the originally purchased product. In contrast to existing buy-back programs, payment of the real-time upgrade pricing displayed by the purchased product upgrade application is all that is required to complete the transaction to trade in the previously purchased device for the upgraded model. A pricing engine stored on the central server contains instructions that determine the upgrade prices for purchased products in real time. The pricing engine continuously computes the real-time upgrade prices for each product stored in the database. The upgrade pricing is determined as a function of estimated trade-in value of the previously purchased device, which will be returned to the manufacturer or retailer, and the cost of the new upgraded model.

The selection of the upgrade option in the purchased product upgrade application additionally causes the upgrade request to be sent to the manufacturer of the upgrade product, as shown at 303. The mobile application may be configured to directly send this information to the manufacturer over a network by using a network communication interface. Alternatively, the request could be sent from the purchased product upgrade application device to the upgrade system at the central server. The upgrade system may then search the information stored in the database to determine the proper manufacturers and retailers and retailers associated with the originally purchased product and the requested upgrade product. The upgrade system may then send a notification of the request to these determined manufacturers and retailers using wired or wireless communication means. For example, the request notification may be sent as an email, as information uploaded onto a webpage accessible over a network, as a facsimile, or as digital information transmitted directly into a manufacturer's or retailer's product management databases. The manufacturer or retailer additionally receives information regarding the trade-in method selected by the customer. If the customer selected to have the previously purchased product picked up, the manufacturer arranges for this pickup and arranges for the new product to be shipped. If the customer selected to complete the transaction at a manufacturer or retail location, the manufacturer or retailer checks the existing products in stock to ensure that the upgrade product is available and arranges for the customer to complete the transaction by bringing in the previously purchased product and picking up the upgrade product.

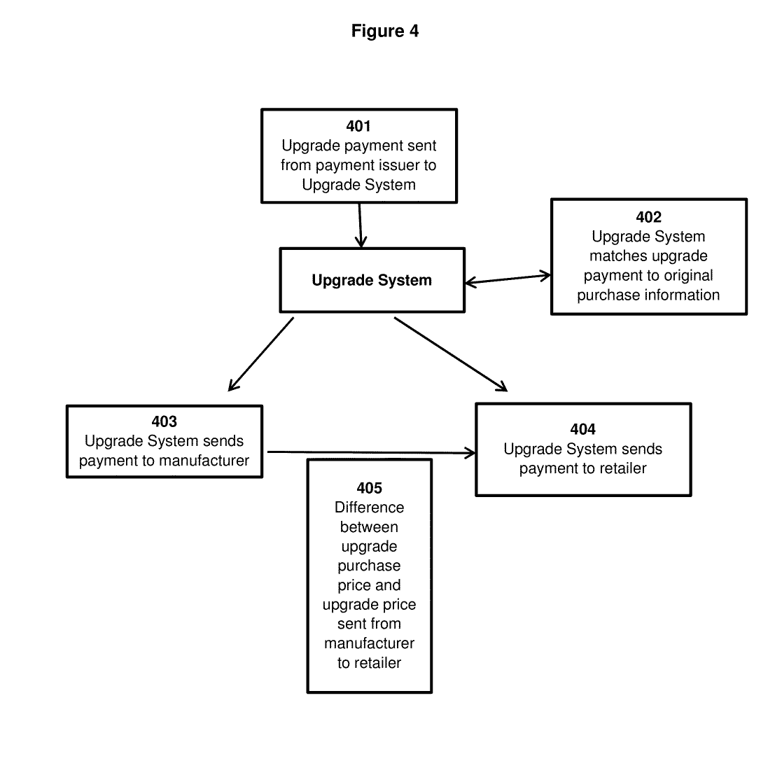

FIG. 4 illustrates the payment process associated with the upgrade transaction. When a customer requests an upgrade through the purchased product upgrade application, the customer is required to enter payment information to complete the upgrade transaction. According to an embodiment where the purchased product upgrade application is hosted on an online website, the customer may be asked to enter payment information into form fields provided on the webpage displayed in the application.

Alternatively, the customer may enter payment information, such as credit card, bank account, or PayPal™ account numbers, as part of a user profile stored within the application program. When the payment is a mobile application, the customer payment information may be entered into fields within the application or may be previously stored as part of a customer profile within the application itself. A payment issuer uses the payment information provided by the customer, and processes an upgrade payment. As shown at 401, the upgrade payment and corresponding upgrade information is sent from the payment issuer to the upgrade system, wherein the payment is matched 402 to the original customer purchase information stored in the database. The upgrade system then sends a proper portion of this payment to the manufacture at 403 and to the retailer at 404. The difference between the upgrade purchase price (or total cost including monetary payment and the value of the returned initially purchased product) and the upgrade price (or monetary value paid by the customer to complete the upgrade transaction) is sent from the manufacturer to the retailer at 405 to reconcile the upgrade transaction amount with the total value received by and distributed from the retailer during the initial and upgrade transactions.

For example, the total cost of the new upgrade device may be $250. In order to upgrade from the previously purchased product to the new product, a customer may be required to pay an upgrade price of $100, with the additional $150 being the trade-in value of the previously purchased device. The upgrade system may complete any processing necessary to send the previously purchased back to the manufacturer, providing the manufacturer with a value of $150 as described above at 403. The upgrade price transaction of $100 may be paid by the customer, to the retailer through the upgrade system as described above at 404. This payment may be made through the mobile payment application. The $150 trade-in value may then be paid from the manufacturer to the retailer to reconcile the upgrade transaction amount as described above at 405.

When the payment transaction is completed, the customer will either receive the new, upgrade device at the retailer or the new, upgrade device will be shipped to the customer's address.

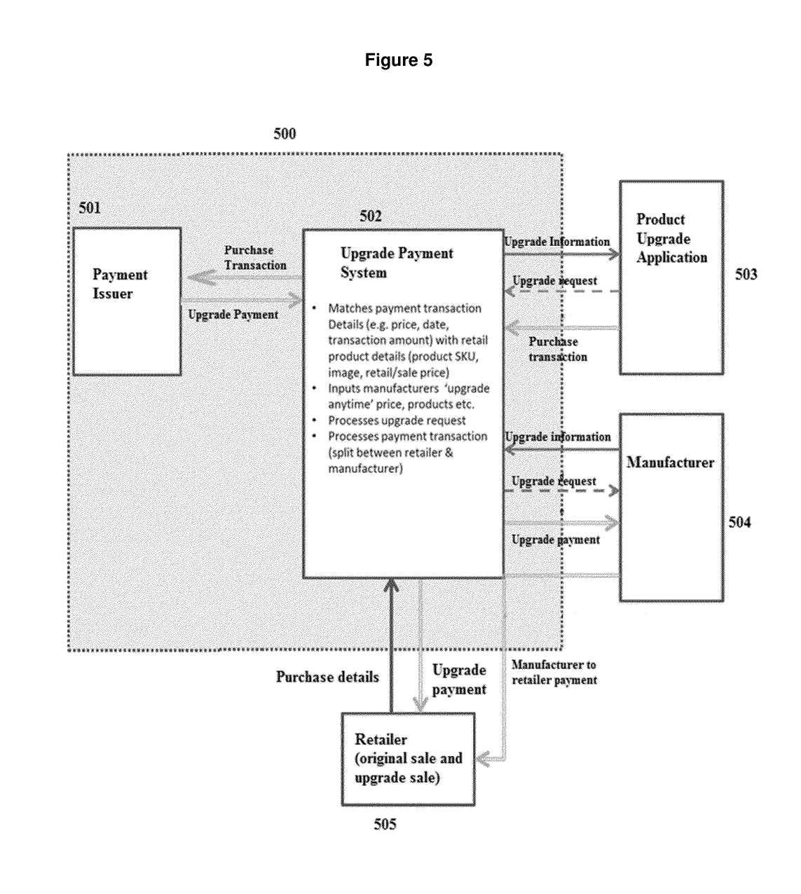

FIG. 5 is an illustration of the upgrade system, customer devices, and retailer and manufacturer components according to one embodiment of the present invention. As shown in FIG. 5, the upgrade system 500 includes a payment issuer 501 and an upgrade payment system 502, including the central server, database, communication interface, and pricing engine. The payment issuer processes the payment information of the initial purchase transaction, and transmits this to the upgrade payment system. The upgrade payment system is in bidirectional communication with purchased product upgrade application 503, which may be an online website or a mobile application, used by the customer in completing the transactions. The upgrade payment system may also be in bidirectional communication with a manufacturer 504 and a retailer 505. The retailer may conduct both the original sale and the upgrade sale. The retailer may be an online retailer wherein customers conduct purchase transactions online through a website, or the retailer may be a physical store location. The customer may use the purchased product upgrade application to make a purchase transaction of a product, and this purchase transaction may be sent to the upgrade payment system. The upgrade payment system may forward this transaction to the payment issuer, which processes the payment and tags the purchase transaction as being eligible for the upgrade option. Information regarding the original purchase is then stored within the upgrade payment system. Alternatively, the information regarding the original purchase may be stored in a separate database, which is accessible by the upgrade payment system. Upon receiving an upgrade request from the customer, the upgrade payment system coordinates with the payment issuer, retailer, and manufacturer to complete the trade-in of the originally purchased device and the transfer of the new, upgrade device to the customer.

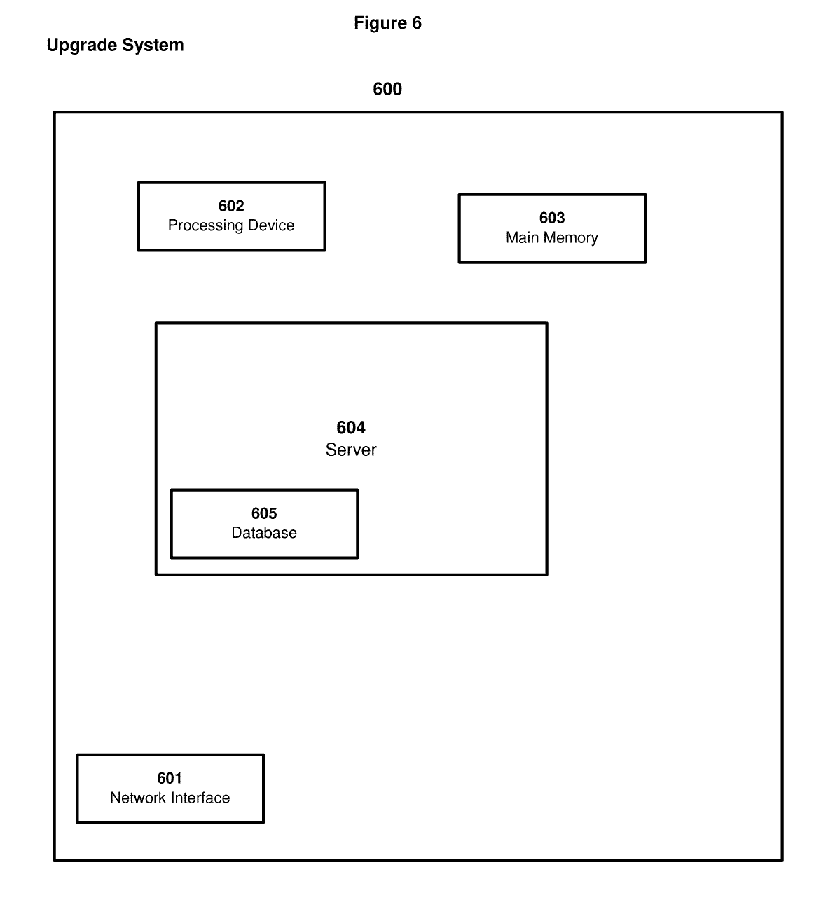

FIG. 6 is an illustration of the components of the upgrade payment system. This system may be in the form of a computer system 600 containing a set of instructions which may be executed to perform any one or more of the processes discussed above. The computer system 600 may include a central server storing program instructions on a computer readable medium and hosting a central database. The upgrade payment system may be connected to the purchased product upgrade application, retailer, and manufacturer over a network such as a local area network, an intranet, an extranet, or the internet through a network interface 601. Computer system 600 may include a processing device 602, a main memory 603, and server memory 604 for storing the database information. The processing device is configured to execute logic for performing the methods and steps disclosed herein. Logic stored in the upgrade system causes the processor to execute a search of the product information stored in the database to match payment transaction details with retail product details. Payment transaction details may include the price, date of the transaction, and transaction amount. Retail product details may include SKU, model or serial number, product image, and the retail or sale price. The processor in the upgrade system further inputs the manufacturers' upgrade pricing, eligible products, and upgrade transaction requirement information into the database. Upon receiving an upgrade request from a customer via the purchased product upgrade application, an upgrade request transaction processing module within the upgrade system searches the database to find information relating to the customer's purchased product and upgrade product choice, and processes the upgrade request. The upgrade system may then interact with the payment issuer to process the payment transaction required to complete the product upgrade transaction through an upgrade completion module within the upgrade system. In doing so, the upgrade payment system may split the payment transaction between the retailer and manufacturer as described above.

In the foregoing, the invention has been described with reference to particular embodiments. However, it is evident that various modification and changes may be made thereto without departing from the broader scope of the invention.

We hereby claim:

1. A method of completing a transaction to upgrade a previously purchased product, comprising:
receiving information related to a purchase transaction of a product purchased by a customer, the information related to the purchase transaction including purchase price and upgrade option information;
receiving information related to the product purchased by the customer;
receiving payment information related to the purchased product from a payment issuer;
linking the product information to the purchase transaction information;
receiving a request to upgrade the purchased product to an upgrade product;
receiving an upgrade payment associated with the request to upgrade the purchased product; and
matching the upgrade request and upgrade payment to the purchase transaction information.

2. The method of claim 1, further comprising initiating distribution of the upgrade product to the customer.

3. The method of claim 1, wherein the product information is received from a manufacturer or retailer.

4. The method of claim 1, wherein the request to upgrade the purchased product is received from a product upgrade application on a mobile device.

5. The method of claim 1, wherein the request to upgrade the purchased product is received through a website over a network connection.

6. The method of claim 1, further comprising providing upgrade product options and upgrade pricing in real time.

7. The method of claim 6, wherein the upgrade pricing is determined as a function of estimated trade-in value of the purchased product and the estimated cost of the upgrade product.

8. The method of claim 1, wherein the upgrade request is transmitted to a manufacturer or retailer.

9. The method of claim 8, wherein the upgrade payment associated with the upgrade request is transmitted to the manufacturer or retailer.

10. A system for completing a transaction to upgrade a previously purchased product, comprising:
an upgrade payment system in communication with a user device; wherein the upgrade payment system is configured to receive purchased product information, the upgrade payment system comprising:
a server storing executable program instructions on a computer readable medium, the program instructions including instructions to search product information stored within a database to determine potential upgrade options for a purchased product;
a pricing engine configured to determine upgrade pricing options; and
a system communication interface allowing wired or wireless communication over a network.

11. The system of claim 10, wherein the upgrade payment system wherein the database comprises a central database storing transaction, payment, and product information.

12. The system of claim 10, wherein the pricing engine is configured to determine initial product pricing and upgrade option pricing.

13. The system of claim 12, wherein the pricing engine is configured to determine and display upgrade pricing options in real time.

14. The system of claim 12, wherein the initial product pricing and upgrade product pricing are sent to the user device communication interface from the system communication interface.

15. The system of claim 10, wherein the upgrade payment system further comprises an upgrade request transaction processing module.

16. The system of claim 11, wherein the upgrade payment system further comprises a matching program configured to match upgrade requests with initial purchase transaction information stored in the central database.

17. The system of claim 16, wherein the upgrade payment system further comprises an upgrade completion module configured to distribute the upgrade product and payments involved in the upgrade transaction.

18. The system of claim 10, further comprising a payment issuer in communication with the upgrade payment system.

19. A user device for transactions to upgrade a previously purchased product, the device comprising:
a customer mobile or web application stored on a computer readable medium, wherein the mobile or web application is configured to initiate requests for a product upgrade from an upgrade payment system;
a communication interface allowing wired or wireless communications over a network;
a purchase transaction module configured to allow a user to complete payment transactions for originally purchased products and upgrade products;
an upgrade request module configured to send a request from the mobile device to an upgrade payment system to initiate a product upgrade transaction; and
a display configured to display purchased product and upgrade options to a user.
